(19) United States
(12) Patent Application Publication
(10) Pub. No.: US 2025/0047172 A1
(43) Pub. Date: Feb. 6, 2025

(54) MOTOR-INTEGRATED ELECTRONIC CONTROL DEVICE AND METHOD FOR MANUFACTURING MOTOR-INTEGRATED ELECTRONIC CONTROL DEVICE

(71) Applicant: Knorr-Bremse Commercial Vehicle Systems Japan Ltd., Sakado-shi, Saitama (JP)

(72) Inventors: Xiaotang GE, Higashimatsuyama-shi, Saitama (JP); Hiroshi AOYAGI, Isesaki-shi, Gunma (JP)

(73) Assignee: Knorr-Bremse Commercial Vehicle Systems Japan Ltd., Sakado-shi, Saitama (JP)

(21) Appl. No.: 18/710,754

(22) PCT Filed: Jun. 16, 2022
(86) PCT No.: PCT/JP2022/024114

§ 371 Date: May 16, 2024

(30) Foreign Application Priority Data
Nov. 18, 2021 (JP) 2021-187459

(51) Int. Cl. H02K 11/30; B60L 1/00; B62D 5/04; H02K 5/02; H02K 9/22

(52) U.S. Cl. CPC H02K 11/30; B60L 1/003; B62D 5/046; H02K 5/02; H02K 9/22; B62D 5/0409; H02K 2211/03

(57) ABSTRACT

In a motor-integrated electronic control device (2) of the present invention, a first connector (61) is provided at a first housing (81) on an opposite side to a motor (4), whereas a second connector (62) is provided at a second housing (82) on the motor (4) side, i.e. the first and second connectors (61, 62) are provided in different directions from each other, namely, that the first and second connectors (61, 62) are provided so as to face to mutually opposite directions. Therefore, a problem of intersection of electric signal of current flowing in electric circuit mounted on a first board (71) and electric signal of current flowing in electric circuit mounted on a second board (72) can be prevented. It is thus possible to suppress adverse effect on the electric circuit of the second board (72) by electric noise generated in the electric circuit of the first board (71).

### TECHNICAL FIELD

The present invention relates to a motor-integrated electronic control device and a method for manufacturing the motor-integrated electronic control device.

### BACKGROUND ART

As an example of a conventional motor-integrated electronic control device, for instance, there is known a motor-integrated electronic control device described in the following Patent Document 1.

To put it briefly, this motor-integrated electronic control device is provided at a power steering device of a vehicle (an automobile), and controls a steering assist force of the power steering device by driving and controlling a motor. More specifically, a power module, a power board and a control board which are connected through a flexible wiring and arranged in layer with the flexible wiring being folded, and a connector member formed by integrally forming a power supply connector and a signal connector are arranged in a stacked state at one end side in an axial direction of the motor, and these power module, power board, control board and connector member are accommodated in a metal case. The power module and the power board are connected to a vehicle-mounted power supply (a battery) through the power supply connector. The control board is connected to a torque steering angle sensor provided at the vehicle-installed power steering device through the signal connector.

### CITATION LIST

### Patent Document

Patent Document 1: Japanese Unexamined Patent Application Publication No. JP2020-108237

### SUMMARY OF THE INVENTION

### Technical Problem

However, the conventional electronic control device has a configuration in which the power module, the power board and the control board are connected to an external device through the integral connector member. Because of this, a control circuit provided on the control board intersects a power circuit in which a relatively large current flows, and consequently, there is a risk that the control circuit will be affected by electric noise.

The present invention was made in view of the above technical problem of the conventional motor-integrated electronic control device. An object of the present invention is therefore to provide a motor-integrated electronic control device that are capable of suppressing the influence of the electric noise emitted from the power circuit system and a manufacturing method of the motor-integrated electronic control device.

### Solution to Problem

As one aspect of the motor-integrated electronic control device according to the present invention, a motor-integrated electronic control device structured by combining a motor and an electronic control device that drives and controls the motor, comprises: a circuit board mounting thereon electronic components for driving and controlling the motor, wherein the circuit board includes a first board and a second board that are arranged so as to face each other in a rotation axis direction of the motor; a housing having a divided structure arranged so as to face each other in the rotation axis direction of the motor, wherein the housing includes a first housing accommodating therein the first board and a second housing accommodating therein the second board; a first connector provided at the first housing on a side opposite to the motor and configured for external connection of the first board; and a second connector provided at the second housing on a side facing the motor and configured for external connection of the second board.

As described above, in the present invention, the first connector is provided at the first housing on the opposite side to the motor, whereas the second connector is provided at the second housing on the motor side, i.e. the first connector and the second connector are provided in different directions (mutually opposite directions) from each other. It is therefore possible to prevent the problem of the intersection of an electric signal of current flowing in an electric circuit mounted on the first board and an electric signal of current flowing in an electric circuit mounted on the second board.

As another aspect of the motor-integrated electronic control device, it is desirable that the first housing is made of metal material, the first board has a power circuit configured to supply power to the motor, and is arranged on a side opposite to the motor in the rotation axis direction of the motor, and the second board has a control circuit configured to drive and control the motor, and is arranged between the first board and the motor in the rotation axis direction of the motor.

As described above, in the present invention, the first board constituting the power circuit is accommodated in the metal first housing arranged on the opposite side to the motor, and heat generated in the first board is dissipated through the first housing that is spaced apart from the motor. Therefore, as compared with a case where heat is dissipated through a motor housing, heat generated in the first board can be effectively dissipated without being affected by the self-heat-generation of the motor.

As still another aspect of the motor-integrated electronic control device, it is desirable that the second housing is made of metal material, the first board is connected to the first housing with a plurality of first metal screws penetrating respective first fixing holes formed at the first board so as to penetrate the first board, and is structured so that a first board copper foil constituting the power circuit on the first board is exposed to a hole edge portion of each first fixing hole, then by the connection of the first board to the first housing by the first screws, the first screws, the first board copper foil and the first housing are connected, and the first board is grounded, and the second board is connected to the second housing with a plurality of second metal screws penetrating respective second fixing holes formed at the second board so as to penetrate the second board, and is structured so that a second board copper foil constituting the control circuit on the second board is exposed to a hole edge portion of each second fixing hole, then by the connection of the second board to the second housing by the second screws, the second screws, the second board copper foil and the second housing are connected, and the second board is grounded.

As described above, in the present invention, the first board is structured so that the first board copper foil is exposed to the hole edge portion of the first fixing hole, and the first board copper foil is grounded to the metal first housing through the first metal screws, and the second board is structured so that the second board copper foil is exposed to the hole edge portion of the second fixing hole, and the second board copper foil is grounded to the metal second housing through the second metal screws. With this, electromagnetic wave noise received from the outside is partially reflected by the first and second housings, and partially absorbed by the first and second housings. Further, an induced current generated by the first and second housings partially absorbing the electromagnetic wave noise can be returned to the outside from GDN of the first connector through the first and second housings. Also, electromagnetic wave noise generated inside (e.g. in the second board constituting the control circuit) is reflected so as not to be emitted to the outside by the first and second housings, and partially absorbed by the first and second housings. Further, an induced current generated by the first and second housings partially absorbing the electromagnetic wave noise can be returned to the outside from GDN of the second board through the first and second housings. In this manner, by this configuration in which the electromagnetic wave noises absorbed by the first and second housings are returned to sources of the electromagnetic wave noises by or through the shortest loop, a signal line on the second board (the control circuit) can be appropriately protected without providing an extra bypass path.

As still another aspect of the motor-integrated electronic control device, it is desirable that the motor is connected to the first board with the motor penetrating the second housing.

As described above, in the present invention, the motor is connected to the first board with the motor penetrating the second housing. With this structure, as compared with a case where the motor and the first board are connected by bypassing the second housing, the motor and the first board can be efficiently connected at a relatively short distance.

As still another aspect of the motor-integrated electronic control device, it is desirable that a power module configured for power conversion for the motor is arranged between the first housing and the first board, and heat of the power module is dissipated through the first housing.

As described above, in the present invention, heat generated in the power module is dissipated through the first housing that is spaced apart from the motor. Therefore, as compared with a case where heat is dissipated through the housing of the motor, heat generated in the power module can be effectively dissipated without being affected by the self-heat-generation of the motor.

As still another aspect of the motor-integrated electronic control device, it is desirable that the power module is located at an inner surface of the first housing so as to be in contact with the inner surface of the first housing through a heat dissipation sheet.

As described above, in the present invention, heat dissipation of the power module is done with the power module being in absolute contact with the inner surface of the first housing through the heat dissipation sheet. With this, heat generated in the power module can be dissipated more effectively.

As still another aspect of the motor-integrated electronic control device, it is desirable that the heat dissipation sheet has insulation properties.

As described above, in the present invention, the power module located at the first housing so as to be in contact with the first housing is insulated through the heat dissipation sheet. With this, it is possible to suppress an adverse effect of transmitting current flowing in the power module and noise generated by this current to the metal first housing.

As still another aspect of the motor-integrated electronic control device, it is desirable that the first board and the second board are electrically connected through an internal connection connector.

As described above, in the present invention, the first board and the second board are directly connected through the internal connection connector. With this structure, an internal structure of the electronic control device can be simplified. A manufacturing cost of the motor-integrated electronic control device can be therefore reduced, and the first board and the second board can be efficiently connected at a relatively short distance. Further, by directly connecting the first board and the second board, manufacturing workability of the motor-integrated electronic control device can be improved, and also productivity of the motor-integrated electronic control device can be increased.

In addition, since a space (an interval) between the first board and the second board is maintained at a predetermined distance by the internal connection connector, an adverse effect on one of the first board and the second board by noise generated in the other of the first board and the second board can be suppressed.

As still another aspect of the motor-integrated electronic control device, it is desirable that the internal connection connector includes a first internal connection connector provided at the first board and a second internal connection connector provided at the second board so as to be able to be fitted to the first internal connection connector, and the second internal connection connector is provided so as to be able to float in a horizontal direction of the second board.

As described above, in the present invention, the second internal connection connector is provided so as to be able to float. Therefore, when coupling the first housing and the second housing, even if a positional deviation between the first internal connection connector provided at the first board accommodated in the first housing and the second internal connection connector provided at the second board accommodated in the second housing occurs due to manufacturing error of the first and second housings and assembling error of the first and second boards with respect to the first and second housings, the positional deviation is absorbed by the floating structure of the second internal connection connector, then the first internal connection connector and the second internal connection connector can be appropriately connected. Connecting workability of the first board and the second board can be improved, and also yield of the motor-integrated electronic control device can be increased.

In addition, as one aspect of the method of manufacturing the motor-integrated electronic control device, a method of manufacturing the motor-integrated electronic control device comprises: a first step of forming a first housing assembly by accommodating the first board in the first housing to which the first connector has been attached and fixing the first board to the first housing; a second step of forming a second housing assembly by accommodating the second board in the second housing to which the second connector has been attached and fixing the second board to the second housing; a third step of forming an ECU assembly by electrically connecting the first board and the second board and coupling the first housing assembly and the second housing assembly; and a fourth step of forming the motor-integrated electronic control device by combining the ECU assembly and the motor.

As described above, in the present invention, at the third step, as the ECU assembly, the electronic control device can be sub-assembled independently of the motor. Therefore, as compared with a conventional method in which the electronic control device is assembled by stacking components or elements such as the boards on the motor, since the heavy motor is not involved when assembling the electronic control device, assembly work of the electronic control device as the ECU assembly is improved by an amount of work equivalent to no-handling of the heavy motor, then assembling work ability of the electronic control device can be improved.

As another aspect of the method of manufacturing the motor-integrated electronic control device, it is desirable that the method further comprises: a first inspection step of inspecting the ECU assembly between the third step and the fourth step.

According to the conventional motor-integrated electronic control device, inspection of the electronic control device is carried out after assembly of the motor-integrated electronic control device is completed. Because of this, if the electronic control device fails the inspection after integrally connecting the electronic control device and the motor, in order to eliminate an abnormality of the electronic control device, it is necessary to reassemble the entire motor-integrated electronic control device. Therefore, there is room for improvement in yield (First Pass Yield) of the motor-integrated electronic control device.

In contrast to this, in the present invention, before connecting the motor and the electronic control device, the electronic control device is inspected alone. It is therefore possible to improve yield (First Pass Yield) of the motor-integrated electronic control device.

As still another aspect of the method of manufacturing the motor-integrated electronic control device, it is desirable that the method further comprises: a second inspection step of inspecting the motor-integrated electronic control device after the fourth step.

As described above, in the present invention, after the inspection of the electronic control device, inspection of the motor-integrated electronic control device configured by combining the electronic control device and the motor is carried out. It is therefore possible to improve yield (First Pass Yield) of the motor-integrated electronic control device.

### Effects of Invention

According to the present invention, since the first connector and the second connector are provided in different directions (mutually opposite directions) from each other, it is possible to prevent the problem of the intersection of the electric signal of current flowing in the electric circuit mounted on the first board and the electric signal of current flowing in the electric circuit mounted on the second board. It is thus possible to suppress adverse effect on the electric circuit of the second board by electric noise generated in the electric circuit of the first board.

### BRIEF DESCRIPTION OF THE DRAWINGS

FIG. 1 is a perspective view of a steering device to which a motor-integrated electronic control device according to the present invention is applied.

FIG. 2 is a perspective view of the motor-integrated electronic control device according to the present invention.

FIG. 3 is an exploded perspective view of the motor-integrated electronic control device shown in FIG. 2.

FIG. 4 is a sectional view taken along a line A-A of FIG. 2.

FIG. 5 is a sectional view taken along a line B-B of FIG. 2.

FIG. 6 is a sectional view taken along a line C-C of FIG. 2.

FIG. 7 is a perspective view of the motor-integrated electronic control device with a housing of the motor-integrated electronic control device shown in FIG. 2 removed.

FIGS. 8A and 8B are sectional views of the motor-integrated electronic control device shown in FIG. 4. FIG. 8A shows a shielding effect against electromagnetic noise received from the outside. FIG. 8B shows a shielding effect against electromagnetic wave noise generated internally.

FIG. 9 is an exploded perspective view of a conventional motor-integrated electronic control device.

### EMBODIMENTS FOR CARRYING OUT THE INVENTION

An embodiment of a motor-integrated electronic control device and a method for manufacturing the motor-integrated electronic control device according to the present invention will be described below with reference to the drawings. The present embodiment shows an example in which as in the conventional case, the motor-integrated electronic control device according to the present invention is applied to an electric power steering device of a vehicle (an automobile). In the following description, a direction along a rotation axis Z of a motor 4 is referred to as an “axial direction”, a direction orthogonal to the rotation axis Z is referred to as a “radial direction”, and a direction of the rotation about the rotation axis Z is referred to as a “circumferential direction”.

### (Configuration of Electric Power Steering Device)

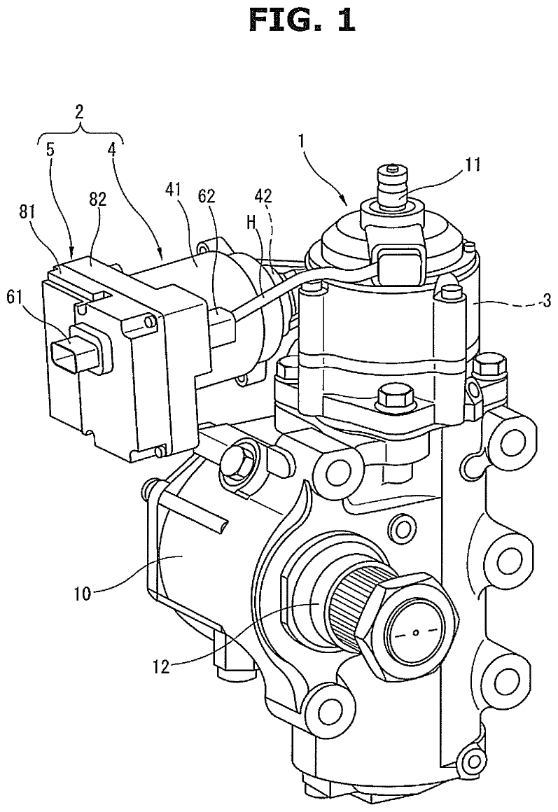

FIG. 1 shows a perspective view of an electric power steering device to which a motor-integrated electronic control device according to the present invention is applied.

As illustrated in FIG. 1, this electric power steering device has a steering device body 1 that changes a direction of steered wheels (not shown) by and according to rotation of a steering shaft 11 and a motor-integrated electronic control device 2 that generates, according to a steering torque that is input to the steering shaft 11, a steering assist torque to assist the steering torque.

These steering device body 1 and motor-integrated electronic control device 2 are integrally connected.

The motor-integrated electronic control device 2 is secured to a side portion of the steering device body 1 with a plurality of bolts (not shown), and a top end side of the motor-integrated electronic control device 2 is supported in a so-called cantilever state.

The steering device body 1 is configured so that the steering shaft 11 is linked to a steering wheel (not shown) and also is connected to the motor-integrated electronic control device 2 through a speed reduction mechanism 3 (e.g. a worm gear) disposed at an outer peripheral side of the steering shaft 11. That is, in a manual operation state, a steering torque is input to the steering device body 1 from the steering wheel (not shown) based on driver's steering operation, whereas in an automatic operation state, a steering torque generated by the motor-integrated electronic control device 2 driven and controlled based on vehicle information is input to the steering device body 1 through the speed reduction mechanism 3.

Further, the steering device body 1 is configured so that the steering shaft 11 and a sector shaft 12 are connected through a sector gear (not shown) accommodated inside a steering case 10, and a top end portion of the sector shaft 12 is connected to the steered wheels (not shown) through a pitman arm (not shown). With this configuration, a rotation operation of the steering shaft 11 is converted into a turning operation of the sector shaft 12 by the sector gear (not shown), and the direction of the steered wheels (not shown) is changed through the pitman arm (not shown) according to the turning operation of the sector shaft 12.

The motor-integrated electronic control device 2 is linked to the steering shaft 11. The motor-integrated electronic control device 2 has a motor 4 giving the steering assist torque to the steering shaft 11 and an electronic control device 5 provided at an opposite side to a drive shaft (not shown) of the motor 4 and driving and controlling the motor 4. The drive shaft (not shown) of the motor 4 is linked to the steering shaft 11 through the speed reduction mechanism 3, and the motor 4 gives the steering assist torque generated by being driven and controlled by the electronic control device 5 to the steering shaft 11. The electronic control device 5 is electrically connected to a steering angle sensor and a torque sensor (both not shown) provided at the steering device body 1 via a harness H, and drives and controls the motor 4 on the basis of detection information of these steering angle sensor and torque sensor.

### (Configuration of Motor-Integrated Electronic Control Device)

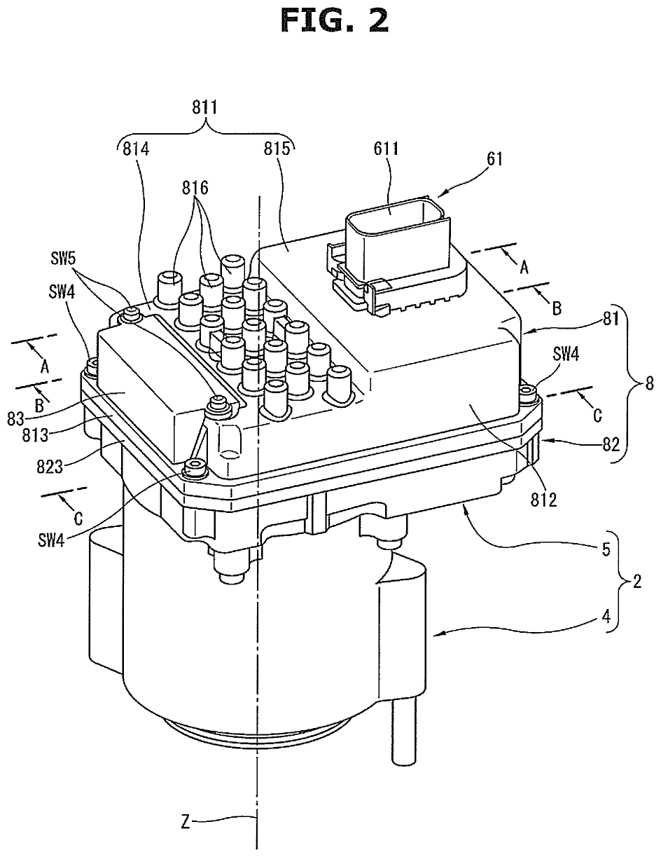

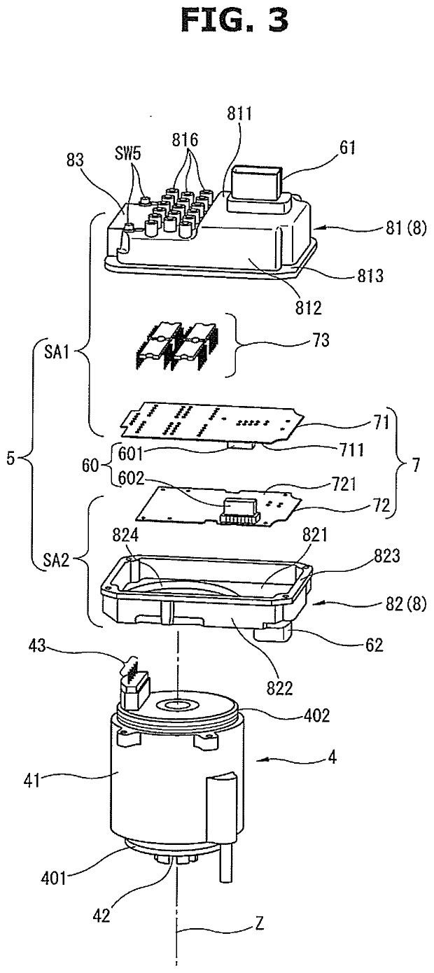

FIG. 2 shows a perspective view of the motor-integrated electronic control device 2. FIG. 3 shows an exploded perspective view of the motor-integrated electronic control device 2 shown in FIG. 2.

The motor-integrated electronic control device 2 is structured so that the motor 4 generating the steering assist torque and the electronic control device 5 driving and controlling the motor 4 are integrally (fixedly) connected to each other at an axial direction end portion (at an upper end portion in FIGS. 2 and 3) of the motor 4 which is the opposite side to the drive shaft (not shown) of the motor 4.

The motor 4 is, for example, a three-phase AC brushless motor. The motor 4 has a motor housing 41 formed into a substantially cylindrical shape with metal material and the drive shaft 42 driven and rotated through motor elements (a rotor and a stator) (not shown) accommodated in the motor housing 41. The motor 4 is provided so that the drive shaft 42 extends from a top end portion 401 that is secured to the steering device body 1, and a three-phase (U-phase, V-phase and W-phase) motor terminal 43 protrudes from a base end portion 402 that is connected to the electronic control device 5. The base end portion 402 of the motor 4 is formed into a stepped reduced-diameter shape with respect to a normal portion, and is shaped so as to be able to be fitted to the electronic control device 5.

The electronic control device 5 has a circuit board 7 mounting thereon electronic components for driving and controlling the motor 4 and a housing 8 having a divided structure arranged so as to face each other in the rotation axis Z direction of the motor 4 and accommodating therein the circuit board 7. The circuit board 7 includes a first board 71 and a second board 72 which are arranged so as to face each other in the rotation axis Z direction of the motor 4. The first board 71 is a power board by which a power circuit (a power supply circuit) that supplies power to the motor 4 is configured, and the first board 71 mounts thereon a power module(s) 73 used for power conversion of the motor 4. On the other hand, the second board 72 is a control board by which a control circuit that drives and controls the motor 4 is configured. The housing 8 includes a first housing 81 and a second housing 82 which are a pair of housings divided in the rotation axis Z direction of the motor 4.

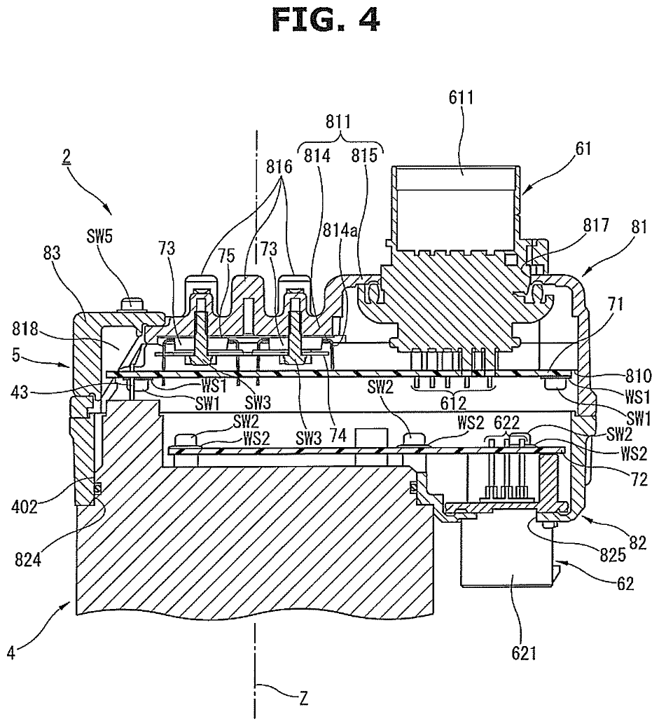

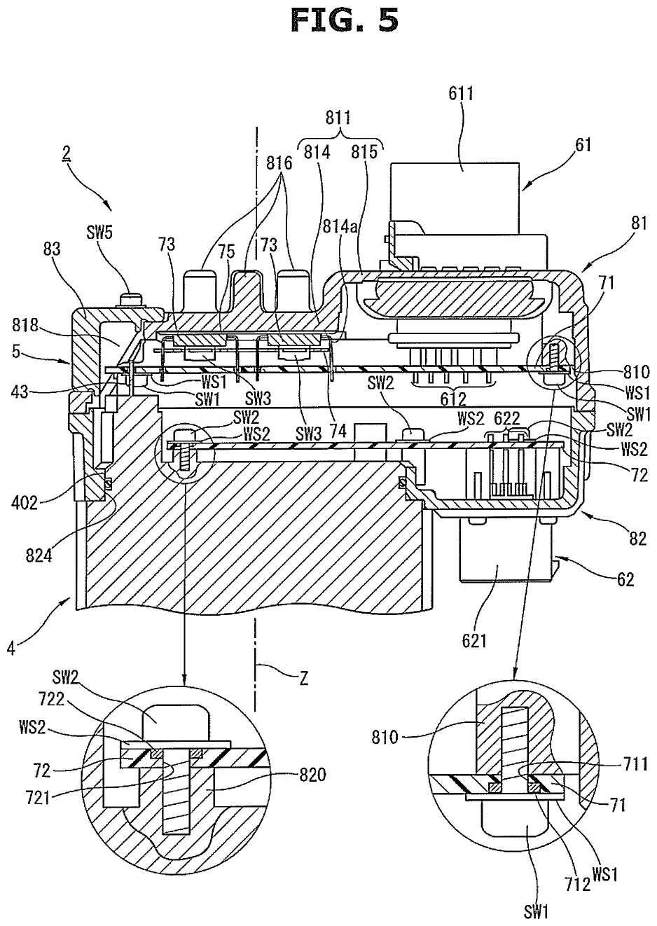

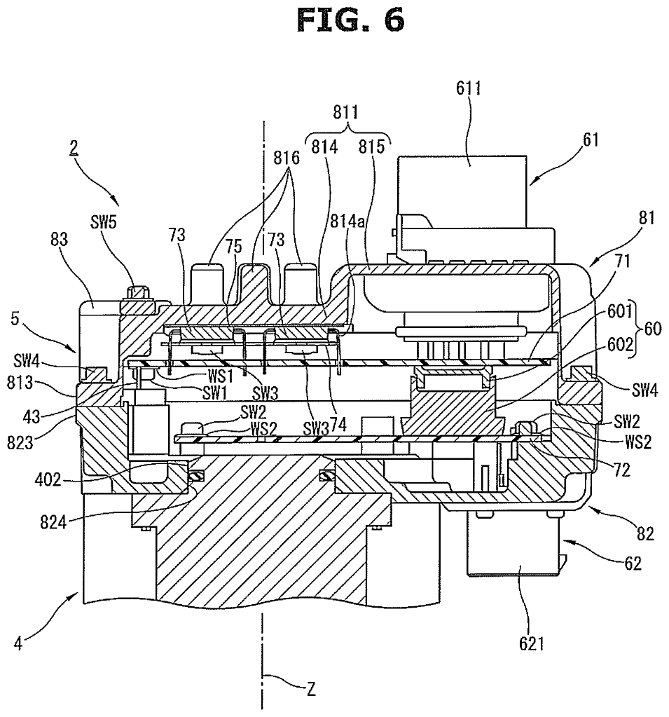

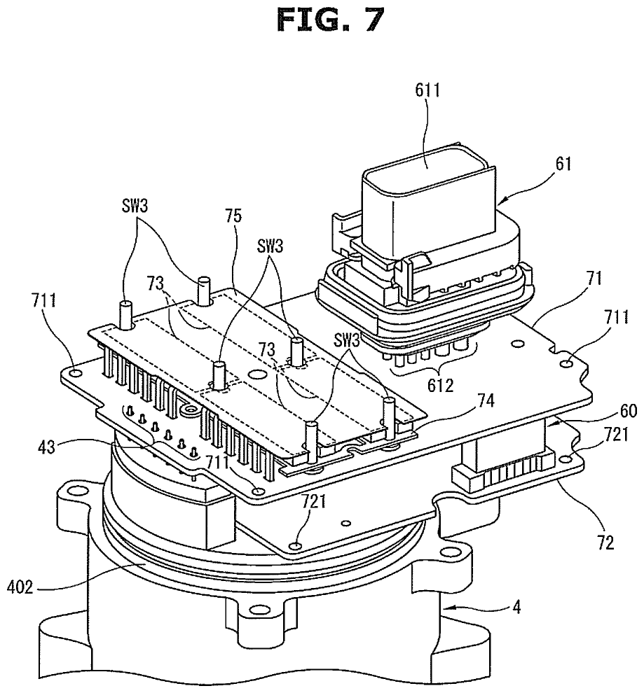

FIG. 4 is a sectional view taken along a line A-A of FIG. 2. FIG. 5 is a sectional view taken along a line B-B of FIG. 2. FIG. 6 is a sectional view taken along a line C-C of FIG. 2. FIG. 7 is a perspective view of the motor-integrated electronic control device 2 with the housing 8 of the motor-integrated electronic control device 2 shown in FIG. 2 removed.

As illustrated in FIGS. 4 to 6, the motor-integrated electronic control device 2 is a so-called electrically mechanically integrated electronic control device in which the electronic control device 5 is secured to the base end portion 402 of the motor 4 so that the motor 4 and the electronic control device 5 are integrally (fixedly) connected to each other. The electronic control device 5 is connected to the base end portion 402 of the motor 4 in series in the axial direction.

The first board 71 is accommodated in the first housing 81, and is fixed to an inner bottom surface (in the present embodiment, an inner bottom surface 814a of a first bottom wall 814) of the first housing 81 with a plurality of first screws SW1. The first board 71 mainly mounts there on a power supply connector(s), a power FET(s) a Zener diode(s), an electrolytic capacitor(s), a power relay(s) (all not shown) and the power module(s) 73, then the power circuit supplying power to the motor 4 is configured by these components or elements. Further, the three-phase (U-phase, V-phase and W-phase) motor terminal 43 provided at the base end portion 402 of the motor 4 so as to protrude from the base end portion 402 is connected to the first board 71 through a motor fitting hole 824 provided at the bottom wall 821 of the second housing 82 so as to penetrate the bottom wall 821. The motor 4 is then supplied with power through the first board 71.

As illustrated in FIGS. 4 to 7, the power module(s) 73 is fixed to the inner bottom surface (in the present embodiment, the inner bottom surface 814a of the first bottom wall 814) of the first housing 81 with a plurality of third screws SW3 with the power module(s) 73 being forced to the first housing 81 side by a metal plate-shaped pressing spring 74. Here, a heat dissipation sheet 75 having insulation properties is interposed between the power module(s) 73 and the first housing 81, and the power module(s) 73 is fixed to the inner bottom surface (in the present embodiment, the inner bottom surface 814a of the first bottom wall 814) of the first housing 81 so as to come into contact with the inner bottom surface 814a through the heat dissipation sheet 75. With this configuration or structure, heat generated in the power module (s) 73 is transmitted ted the first housing 81 through the heat dissipation sheet 75, and is dissipated to the outside through the first housing 81.

Further, as illustrated in, for instance, FIG. 5, a plurality of first fixing holes 711 which respective shaft portions of the plurality of first screws SW1 can penetrate are formed at a peripheral edge portion of the first board 71 so as to penetrate the peripheral edge portion of the first board 71. With this structure, by screwing the first screws SW1 inserted into the first fixing holes 711 into a plurality of boss portions 810 that are formed integrally with a bottom wall 811 of the first housing 81, the first board 71 is connected to the first housing 81. Here, each first fixing hole 711 of the first board 71 is structured so that a first board copper foil (a first substrate copper foil) 712 constituting the power circuit is exposed to a hole edge portion of the first fixing hole 711 of the first board 71. With this structure, by connecting the first board 71 to the first housing 81 with the plurality of first screws SW1, the first screws SW1 come into contact with the first board copper foils 712 through respective washers WS1, and also the first board copper foils 712 come into contact with the boss portions 810 of the first housing 81, then the power circuit configured on the first board 71 is grounded (earthed).

As illustrated in FIGS. 4 to 6, the second board 72 is fixed to an inner bottom surface 821a of the second housing 82 with a plurality of second screws SW2, and is accommodated in the second housing 82. The second board 72 mainly mounts thereon a microcomputer (s), a power IC (s) a pre-driver(s) and an electrolytic capacitor(s) (all not shown), then the control circuit driving and controlling the motor 4 is configured by these components or elements.

Further, similar to the first board 71, as illustrated in, for instance, FIG. 5, a plurality of second fixing holes 721 which respective shaft portions of the plurality of second screws SW2 can penetrate are formed at a peripheral edge portion of the second board 72 so as to penetrate the peripheral edge portion of the second board 72. With this structure, by screwing the second screws SW2 inserted into the second fixing holes 721 into a plurality of boss portions 820 that are formed integrally with the bottom wall 821 of the second housing 82, the second board 72 is connected to the second housing 82. Here, each second fixing hole 721 of the second board 72 is structured so that a second board copper foil (a second substrate copper foil) 722 constituting the control circuit is exposed to a hole edge portion of the second fixing hole 721 of the second board 72. With this structure, by connecting the second board 72 to the second housing 82 with the plurality of second screws SW2, the second screws SW2 come into contact with the second board copper foils 722 through respective washers WS2, and also the second board copper foils 722 come into contact with the boss portions 820 of the second housing 82, then the control circuit configured on the second board 72 is grounded (earthed).

As illustrated in FIGS. 6 and 7, the first board 71 and the second board 72 are electrically connected through an internal connection connector 60 formed by a pair of male and female connectors provided so as to face respective inner surfaces of the second and first boards 72 and 71. The internal connection connector 60 is a so-called Board-to-Board connector. The internal connection connector 60 is configured by a first internal connection connector 601 as the male connector provided at the first board 71 side and a second internal connection connector 602 as the female connector provided at the second board 72 side. With this configuration, the first board 71 and the second board 72 are spaced apart from each other in the axial direction by an axial direction length L of the internal connection connector 60, and this distance is maintained. Further, the internal connection connector 60 has a floating structure in which the female-side second internal connection connector 602 can move in a horizontal direction. Then, when fitting the first internal connection connector 601 into the second internal connection connector 602, a position of the second internal connection connector 602 can be adjusted.

The first housing 81 is made of metal material having relatively high heat dissipation properties such as aluminium alloy, and is formed into a bottomed rectangular tubular shape in which one side, which faces the second housing 82 in the axial direction, of the first housing 81 is open and the other side of the first housing 81 is closed by the bottom wall 811. The first housing 81 has a side wall 812 that stands from a peripheral edge portion of the bottom wall 811 substantially perpendicularly to the peripheral edge portion of the bottom wall 811. The first housing 81 is connected to the second housing 82 with a plurality of fourth screws SW4 through a brim-shaped flange portion 813 provided at a top end portion of the side wall 812.

The bottom wall 811 of the first housing 81 is formed into a stepped shape in a width direction (in right and left directions of FIGS. 4 to 6), and has a first bottom wall 814 provided at a relatively high position and having a relatively short distance to the second housing 82 and a second bottom wall 815 provided at a lower position than the first bottom wall 814 by bulging out to the outside with respect to the first bottom wall 814 and having a relatively long distance to the second housing 82.

A plurality of heat dissipation fins 816 are formed on an outer surface, which faces the outside, of the first bottom wall 814, and the power module(s) 73 is located at an inner surface of the first bottom wall 814 so as to be in contact with the inner surface of the first bottom wall 814. With this structure, heat transmitted from the power module(s) 73 to the first bottom wall 814 of the first housing 81 can be efficiently dissipated via the heat dissipation fins 816. In addition, heat dissipation capability can be adjusted depending on a shape of the heat dissipation fin 816 and the number of the heat dissipation fins 816.

The second bottom wall 815 is formed into a flat shape. The second bottom wall 815 has, at a middle position thereof, a first connector penetration hole 817 into which a substantially rectangular first connector 61 can be inserted. A first connector opening 611 is fixed to the first connector 61 so as to face to an opposite direction to the motor 4 in the axial direction, and a plurality of first connector metal terminals 612 accommodated in the first connector opening 611 are connected to the first board 71 by soldering. The first connector 61 is connected to a power supply (a battery) on the vehicle side via a harness (not shown), and power (the power supply) on the vehicle side is led to the power circuit configured on the first board 71 through the first connector 61.

Further, as illustrated in FIGS. 4 and 5, the first housing 81 has, at an end portion (a corner portion) in the width direction (in the right and left directions of FIGS. 4 and 5) of the first bottom wall 814, a window portion 818 that is open to make a connection part between the motor terminal 43 and the first board 71 face to the outside. Then, when connecting the motor 4 and the electronic control device 5, it is possible to solder the motor terminal 43 to the first board 71 from the outside through the window portion 818. It is noted that this window portion 818 is covered with a cover member 83 that is fixed to the first housing 81 with a plurality of screws SW5 after soldering the motor terminal 43.

The second housing 82 is made of metal material such as aluminium alloy, and is formed into a bottomed rectangular tubular shape in which one side, which faces the first housing 81 in the axial direction, of the second housing 82 is open and the other side of the second housing 82 is closed by the bottom wall 821. The second housing 82 has a side wall 822 that stands from a peripheral edge portion of the bottom wall 821 substantially perpendicularly to the peripheral edge portion of the bottom wall 821. The second housing 82 is connected to the first housing 81 with the plurality of fourth screws SW4 screwed into a brim-shaped flange portion 823 provided at a top end portion of the side wall 822.

The second housing 82 has, at a substantially middle position at one end side in the width direction (in the right and left directions of FIGS. 4 to 6) on the bottom wall 821, the motor fitting hole 824 which is formed so as to penetrate the bottom wall 821 along the axial direction and to which the base end portion 402 of the motor 4 can be fitted. The second housing 82 further has, at the other end side in the width direction on the bottom wall 821, a second connector penetration hole 825 into which a substantially rectangular second connector 62 can be inserted. A second connector opening 621 is fixed to the second connector 62 so as to face the motor 4 side, i.e. so as to face to an opposite direction to the first connector 61 in the axial direction, and a plurality of second connector metal terminals 622 accommodated in the second connector opening 621 are connected to the second board 72 by soldering. The second connector 62 is connected to the steering angle sensor and the torque sensor (both not shown) provided at the steering device body 1 via the harness H (see FIG. 1), and detection signals of the steering angle sensor and the torque sensor are led and input to the control circuit configured on the second board 72 through the second connector 62. [0060](Manufacturing method of Motor-integrated electronic control device) A manufacturing method (an assembling method) of the motor-integrated electronic control device 2 will be described below mainly with reference to FIG. 3. Since the motor 4 and the electronic control device 5 can be assembled independently of each other as described later, the manufacturing method will be described as an example in which the motor 4 is assembled in another line.

First, at a first step, a first housing assembly SA1 is assembled. More specifically, the power module (s) 73 is fixed to the first bottom wall 814 of the first housing 81 while being in absolute contact with first bottom wall 814 through the pressing spring 74 and the heat dissipation sheet 75, and the first connector 61 is inserted into the first connector penetration hole 817 from an inner side of the first bottom wall 814 and attached to the second bottom wall 815. After that, the first board 71 is inserted into the first housing 81 and fixed to the first housing 81 with the plurality of first screws SW1, and the power module(s) 73 and the first connector metal terminals 612 are soldered to the first board 71. With this, assembly of the first housing assembly SA1 is completed.

Next, at a second step, a second housing assembly SA2 is assembled. More specifically, the second connector 62 is inserted into the second connector penetration hole 825 from an inner side of the bottom wall 821 of the second housing 82 and attached to the bottom wall 821. After that, the second board 72 is inserted into the second housing 82 and fixed to the second housing 82 with the plurality of second screws SW2, and the second connector metal terminals 622 are soldered to the second board 72. With this, assembly of the second housing assembly SA2 is completed.

Next, at a third step, the first board 71 of the first housing assembly SA1 and the second board 72 of the second housing assembly SA2 are connected through the internal connection connector 60, and the first housing assembly SA1 and the second housing assembly SA2 are connected to each other with the plurality of fourth screws SW4, then the assembly of the electronic control device 5 as an ECU assembly is completed. Further, after the third step, at a first inspection step, inspection of the assembled electronic control device 5 as the ECU assembly is carried out.

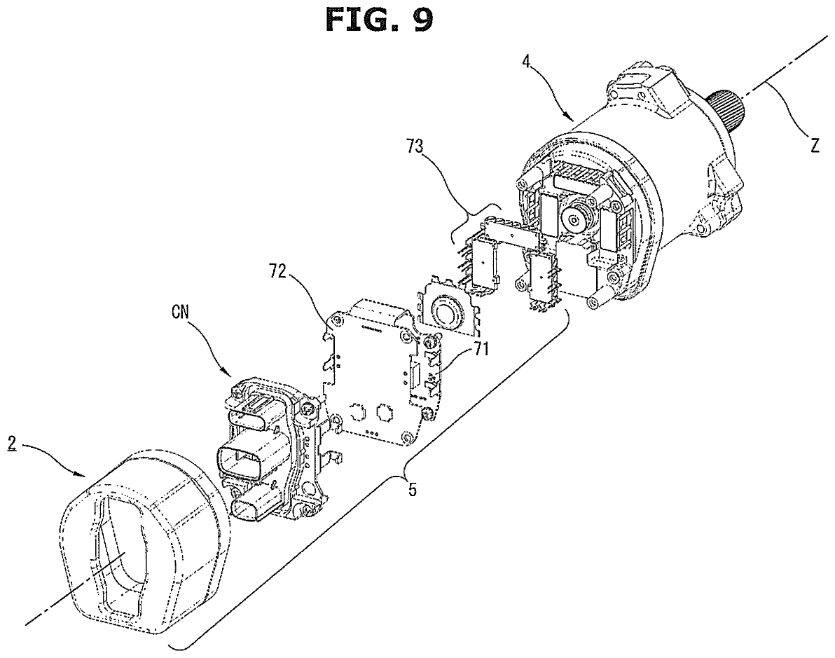

Next, at a fourth step, the electronic control device 5 as the ECU assembly having passed the inspection at the ECU inspection step is secured to the motor 4, then the motor 4 and the electronic control device 5 are connected. More specifically, the base end portion 402 of the motor 4 is fitted to the motor fitting hole 824, and the motor terminal 43 is soldered to the first board 71 through the window portion 818 of the first housing 81. After that, the cover member 83 is attached to the window portion 818, then the window portion 818 is covered with the cover member 83, and the motor 4 and the electronic control device 5 are connected to each other with a plurality of screws (not shown), thereby completing assembly of the motor-integrated electronic control device 2. Further, after the fourth step, at a second inspection step, inspection of the assembled motor-integrated electronic control device 2 is carried out, and the assembled motor-integrated electronic control device 2 having passed the second inspection step is shipped as a finished product. [0065](Working and Effect of the present embodiment) The conventional motor-integrated electronic control device has a configuration in which, as illustrated in FIG. 9, a power module (s) 73, a first board 71 as a power board and a second board 72 as a control board are connected to an external device (not shown) via an integral connector member CN. Because of this, an electric signal of a relatively large current flowing in the power circuit configured on the first board 71 and an electric signal of a current flowing in the control circuit configured on the second board 72 intersect, and consequently, there is a risk that the control circuit configured on the second board 72 will be affected by electric noise.

In addition, in the conventional motor-integrated electronic control device, the power module (s) 73 arranged adjacently to the motor 4 is configured so that heat of the power module(s) 73 is dissipated through a motor housing 41. Because of this, dissipation of the heat of the power module(s) 73 is affected by self-heat-generation of the motor 4, and consequently, there is a risk that the heat of the power module (s) 73 cannot be sufficiently dissipated.

In contrast to these problems, according to the motor-integrated electronic control device 2 of the present invention, it is possible to solve the problems of the conventional motor-integrated electronic control device by achieving the following effects.

The motor-integrated electronic control device 2 according to the present invention structured by combining the motor 4 and the electronic control device 5 that drives and controls the motor 4, comprises: the circuit board 7 mounting thereon electronic components for driving and controlling the motor 4, wherein the circuit board 7 includes the first board 71 and the second board 72 that are arranged so as to face each other in the rotation axis Z direction of the motor 4; the housing 8 having the divided structure arranged so as to face each other in the rotation axis Z direction of the motor 4, wherein the housing 8 includes the first housing 81 accommodating therein the first board 71 and the second housing 82 accommodating therein the second board 72; the first connector 61 provided at the first housing 81 on a side opposite to the motor 4 and configured for external connection of the first board 71; and the second connector 62 provided at the second housing 82 on a side facing the motor 4 and configured for external connection of the second board 72.

As described above, according to the present embodiment, the first connector 61 is provided at the first housing 81 on the opposite side to the motor 4, whereas the second connector 62 is provided at the second housing 82 on the motor 4 side, i.e. the first connector 61 and the second connector 62 are provided in different directions from each other, namely, that the first connector 61 and the second connector 62 are provided so as to face to mutually opposite directions. It is therefore possible to prevent the problem of the intersection of the electric signal of the relatively large current flowing in an electric circuit (the power circuit) mounted on the first board 71 and the electric signal of the current flowing in an electric circuit (the control circuit) mounted on the second board 72. With this, it is possible to suppress the adverse effect on the electric circuit (the control circuit) of the second board 72 by the electric noise generated in the electric circuit (the power circuit) of the first board 71.

Further, in the present embodiment, the first housing 81 is made of metal material. The first board 71 has the power circuit configured to supply power to the motor 4, and is arranged on the side opposite to the motor 4 in the rotation axis Z direction of the motor 4. Further, the second board 72 has the control circuit configured to drive and control the motor 4, and is arranged between the first board 71 and the motor 4 in the rotation axis Z direction of the motor 4.

As described above, in the present embodiment, the first board 71 constituting the power circuit is accommodated in the metal first housing 81 arranged on the opposite side to the motor 4, and heat generated in the first board 71 is dissipated through the first housing 81 that is spaced apart from the motor 4. Therefore, as compared with a case where heat is dissipated through the motor housing 41 of the motor 4, heat generated in the first board 71 can be effectively dissipated without being affected by the self-heat-generation of the motor 4.

Further, in the present embodiment, the second housing 82 is made of metal material. The first board 71 is connected to the first housing 81 with the plurality of first metal screws SW1 penetrating the respective first fixing holes 711 formed at the first board 71 so as to penetrate the first board 71, and is structured so that the first board copper foil 712 constituting the power circuit on the first board 71 is exposed to the hole edge portion of each first fixing hole 711, then by the connection of the first board 71 to the first housing 81 by the first screws SW1, the first screws SW1, the first board copper foil 712 and the first housing 81 are connected, and the first board 71 is grounded. Further, the second board 72 is connected to the second housing 82 with the plurality of second metal screws SW2 penetrating the respective second fixing holes 721 formed at the second board 72 so as to penetrate the second board 72, and is structured so that the second board copper foil 722 constituting the control circuit on the second board 72 is exposed to the hole edge portion of each second fixing hole 721, then by the connection of the second board 72 to the second housing 82 by the second screws SW2, the second screws SW2, the second board copper foil 722 and the second housing 82 are connected, and the second board 72 is grounded.

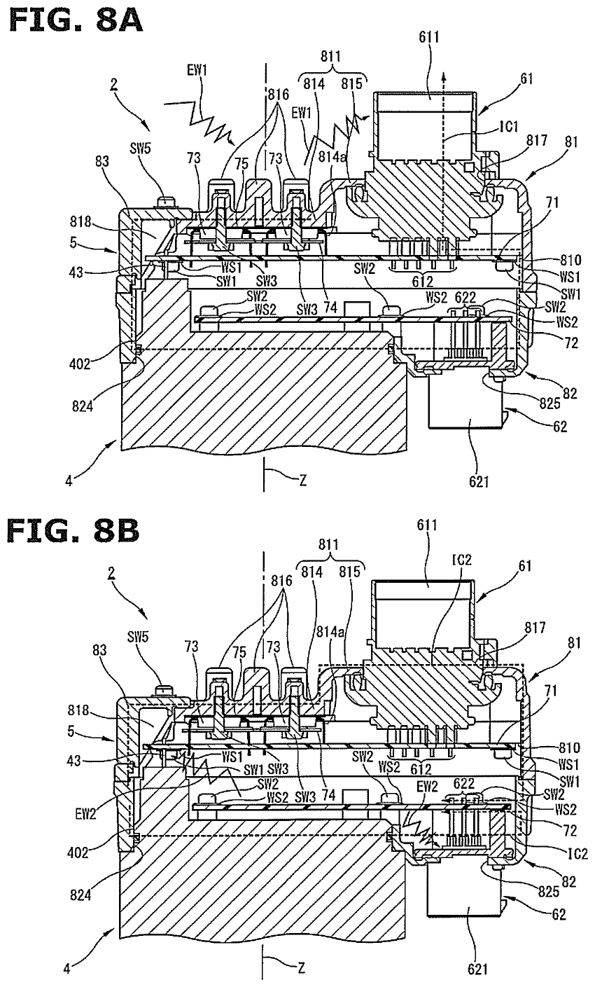

As described above, in the present embodiment, the first board 71 is structured so that the first board copper foil 712 is exposed to the hole edge portion of the first fixing hole 711, and the first board copper foil 712 is grounded to the metal first housing 81 through the first metal screws SW1, and the second board 72 is structured so that the second board copper foil 722 is exposed to the hole edge portion of the second fixing hole 721, and the second board copper foil 722 is grounded to the metal second housing 82 through the second metal screws SW2. With this, as illustrated in FIG. 8A, electromagnetic wave noise EW1 received from the outside is partially reflected by the first and second housings 81 and 82, and partially absorbed by the first and second housings 81 and 82. Further, as indicated by an arrow A1 in FIG. 8A, an induced current IC1 generated by the first and second housings 81 and 82 partially absorbing the electromagnetic wave noise EW1 can be returned to the outside from GDN of the first connector 61 through the first and second housings 81 and 82. Also, as illustrated in FIG. 8B, electromagnetic wave noise EW2 generated inside (e.g. in the second board 72 constituting the control circuit) is reflected so as not to be emitted to the outside by the first and second housings 81 and 82, and partially absorbed by the first and second housings 81 and 82. Further, as indicated by an arrow A2 in FIG. 8B, an induced current IC2 generated by the first and second housings 81 and 82 partially absorbing the electromagnetic wave noise EW2 can be returned to the outside from GDN of the second board 72 through the first and second housings 81 and 82. In this manner, by this configuration in which the electromagnetic wave noises EW1 and EW2 absorbed by the first and second housings 81 and 82 are returned to sources of the electromagnetic wave noises EW1 and EW2 by or through the shortest loop, a signal line on the second board 72 (the control circuit) can be appropriately protected without providing an extra bypass path.

Further, in the present embodiment, the motor 4 is connected to the first board 71 with the motor 4 penetrating the second housing 82.

As described above, in the present embodiment, the motor 4 (the motor terminal 43) is connected to the first board 71 with the motor 4 penetrating the second housing 82. With this structure, as compared with a case where the motor 4 and the first board 71 are connected by bypassing the second housing 82, the motor 4 and the first board 71 can be efficiently connected at a relatively short distance.

Further, in the present embodiment, the power module(s) 73 configured for power conversion for the motor 4 is arranged between the first housing 81 and the first board 71, and heat of the power module (s) 73 is dissipated through the first housing 81.

As described above, in the present embodiment, heat generated in the power module(s) 73 is dissipated through the first housing 81 that is spaced apart from the motor 4. Therefore, as compared with a case where heat is dissipated through the housing of the motor 4, heat generated in the power module (s) 73 can be effectively dissipated without being affected by the self-heat-generation of the motor 4.

Further, in the present embodiment, the power module (s) 73 is located at the inner surface of the first housing 81 so as to be in contact with the inner surface of the first housing 81 through the heat dissipation sheet 75.

As described above, in the present embodiment, heat dissipation of the power module(s) 73 is done with the power module(s) 73 being in absolute contact with the inner surface of the first housing 81 through the heat dissipation sheet 75. With this, heat generated in the power module (s) 73 can be dissipated more effectively.

Further, in the present embodiment, the heat dissipation sheet 75 has insulation properties.

As described above, in the present embodiment, the power module(s) 73 located at the first housing 81 so as to be in contact with the first housing 81 is insulated through the heat dissipation sheet 75. With this, it is possible to suppress an adverse effect of transmitting current flowing in the power module(s) 73 and noise generated by this current to the metal first housing 81.

Further, in the present embodiment, the first board 71 and the second board 72 are electrically connected through the internal connection connector 60.

As described above, in the present embodiment, the first board 71 and the second board 72 are directly connected through the internal connection connector 60.

With this structure, an internal structure of the electronic control device 5 can be simplified. A manufacturing cost of the motor-integrated electronic control device 2 can be therefore reduced, and the first board 71 and the second board 72 can be efficiently connected at a relatively short distance. Further, by directly connecting the first board 71 and the second board 72, manufacturing workability of the motor-integrated electronic control device 2 can be improved, and also productivity of the motor-integrated electronic control device 2 can be increased.

In addition, since a space (an interval) between the first board 71 and the second board 72 is maintained at a predetermined distance L by the internal connection connector 60, an adverse effect on one of the first board 71 and the second board 72 by noise generated in the other of the first board 71 and the second board 72 can be suppressed.

Further, in the present embodiment, the internal connection connector 60 includes the first internal connection connector 601 provided at the first board 71 and the second internal connection connector 602 provided at the second board 72 so as to be able to be fitted to the first internal connection connector 601, and the second internal connection connector 602 is provided so as to be able to float (move) in the horizontal direction of the second board 72.

As described above, in the present embodiment, the second internal connection connector 602 is provided so as to be able to float (move) in the horizontal direction of the second board 72. Therefore, when coupling the first housing 81 and the second housing 82, even if a positional deviation between the first internal connection connector 601 provided at the first board 71 accommodated in the first housing 81 and the second internal connection connector 602 provided at the second board 72 accommodated in the second housing 82 occurs due to manufacturing error of the first and second housings 81 and 82 and assembling error of the first and second boards 71 and 72 with respect to the first and second housings 81 and 82, the positional deviation is absorbed by the floating structure of the second internal connection connector 602, then the first internal connection connector 601 and the second internal connection connector 602 can be appropriately connected. Connecting workability of the first board 71 and the second board 72 can be improved, and also yield of the motor-integrated electronic control device 2 can be increased.

Furthermore, in the present embodiment, the method of manufacturing the motor-integrated electronic control device 2 comprises: the first step of forming the first housing assembly SA1 by accommodating the first board 71 in the first housing 81 to which the first connector 61 has been attached and fixing the first board 71 to the first housing 81; the second step of forming the second housing assembly SA2 by accommodating the second board 72 in the second housing 82 to which the second connector 62 has been attached and fixing the second board 72 to the second housing 82; the third step of forming the ECU assembly (the electronic control device 5) by electrically connecting the first board 71 and the second board 72 and coupling the first housing assembly SA1 and the second housing assembly SA2; and the fourth step of forming the motor-integrated electronic control device 2 by combining the ECU assembly (the electronic control device 5) and the motor 4.

As described above, in the present embodiment, at the third step, as the electronic control device 5 that is the ECU assembly, the electronic control device 5 can be sub-assembled independently of the motor 4. Therefore, as compared with a conventional method (see FIG. 9) in which the electronic control device 5 is assembled by stacking components or elements such as the boards on the motor 4, since the heavy motor 4 is not involved when assembling the electronic control device 5, assembly work of the electronic control device 5 as the ECU assembly is improved by an amount of work equivalent to no-handling of the heavy motor 4, then assembling workability of the electronic control device 5 can be improved.

Further, in the present embodiment, the method of manufacturing the motor-integrated electronic control device 2 further comprises: the first inspection step of inspecting the ECU assembly (the electronic control device 5) between the third step and the fourth step.

In the case of the configuration of the conventional motor-integrated electronic control device 2, inspection of the electronic control device 5 is carried out after assembly of the motor-integrated electronic control device 2 is completed. Because of this, if the electronic control device 5 fails the inspection after integrally connecting the electronic control device 5 and the motor 4, in order to eliminate an abnormality of the electronic control device 5, it is necessary to reassemble the entire motor-integrated electronic control device 2. Therefore, there is room for improvement in yield (First Pass Yield) of the motor-integrated electronic control device 2.

In contrast to this, in the present embodiment, before connecting the motor 4 and the electronic control device 5, the electronic control device 5 is inspected alone. Therefore, even if the electronic control device 5 fails the inspection, in order to eliminate an abnormality of the electronic control device 5 having failed the inspection, it is merely required to reassemble the electronic control device 5 alone, and there is no need to reassemble the entire motor-integrated electronic control device 2. Hence, it is possible to improve yield (First Pass Yield) of the motor-integrated electronic control device 2.

Further, in the present embodiment, the method of manufacturing the motor-integrated electronic control device 2 further comprises: the second inspection step of inspecting the motor-integrated electronic control device 2 after the fourth step.

As described above, in the present embodiment, after the inspection of the electronic control device 5, inspection of the motor-integrated electronic control device 2 configured by combining the electronic control device 5 and the motor 4 is carried out. According to this method, at the time of combining the electronic control device 5 and the motor 4, the electronic control device 5 has already been inspected and become a good product. Therefore, even if the motor-integrated electronic control device 2 fails the inspection at the second inspection step, in order to eliminate an abnormality of the motor-integrated electronic control device 2, it is merely required to check a connecting state of the motor 4 and the electronic control device 5 again, and there is no need to reassemble the entire motor-integrated electronic control device 2. Hence, it is possible to improve yield (First Pass Yield) of the motor-integrated electronic control device 2.

The present invention is not limited to the configurations or structures exemplified in the above embodiment. As long as above-described working and effect of the present invention can be obtained, the present invention can be freely changed according to specification, cost etc. of objects to which the present invention is applied.

Especially in the above embodiment, as an example, the second housing 82 is made of metal material. However, since the necessity of dissipating heat of the second board 72 whose heat value (heat generation amount) is relatively small through the second housing 82 is low, the second housing 82 could be made of resin material.

1. A motor-integrated electronic control device structured by combining a motor and an electronic control device that drives and controls the motor, the motor-integrated electronic control device comprising:
a circuit board mounting thereon electronic components for driving and controlling the motor, wherein the circuit board includes a first board and a second board that are arranged so as to face each other in a rotation axis direction of the motor;
a housing having a divided structure arranged so as to face each other in the rotation axis direction of the motor, wherein the housing includes a first housing accommodating therein the first board and a second housing accommodating therein the second board;
a first connector provided at the first housing on a side opposite to the motor and configured for external connection of the first board; and
a second connector provided at the second housing on a side facing the motor and configured for external connection of the second board.

2. The motor-integrated electronic control devices claimed in claim 1, wherein
the first housing is made of metal material,
the first board has a power circuit configured to supply power to the motor, and is arranged on a side opposite to the motor in the rotation axisirection of the motor, and
the second board has a control circuit configured to drive and control the motor, and is arranged between the first board and the motor in the rotation axisirection of the motor.

3. The motor-integrated electronic control device as claimed in claim 2, wherein
the second housing is made of metal material,
the first board is connected to the first housing with a plurality of first metal screws penetrating respective first fixing holes formed at the first board so as to penetrate the first board, and is structured so that a first board copper foil constituting the power circuit on the first board is exposed to a hole edge portion of each first fixing hole, then by the connection of the first board to the first housing by the first screws, the first screws, the first board copper foil and the first housing are connected, and the first board is grounded, and
the second board is connected to the second housing with a plurality of second metal screws penetrating respective second fixing holes formed at the second board so as to penetrate the second board, and is structured so that a second board copper foil constituting the control circuit on the second board is exposed to a hole edge portion of each second fixing hole, then by the connection of the second board to the second housingy the second screws, the second screws, the second board copper foil and the second housing are connected, and the second board is grounded.

4. The motor-integrated electronic control device as claimed in claim 2, wherein
the motor is connected to the first board with the motor penetrating the second housing.

5. The motor-integrated electronic control device as claimed in claim 2, wherein
a power module configured for power conversion for the motor is arranged between the first housing and the first board, and
heat of the power module is dissipated through the first housing.

6. The motor-integrated electronic control device as claimed in claim 5, wherein
the power module is located at an inner surface of the first housing so as to be in contact with the inner surface of the first housing through a heat dissipation sheet.

7. The motor-integrated electronic control device as claimed in claim 6, wherein
the heat dissipation sheet has insulation properties.

8. The motor-integrated electronic control device as claimed in claim 1, wherein
the first board and the second board are electrically connected through an internal connection connector.

9. The motor-integrated electronic control device as claimed in claim 8, wherein
the internal connection connector includes a first internal connection connector provided at the first board and a second internal connection connector provided at the second board so as to be able to be fitted to the first internal connection connector, and
the second internal connection connector is provided so as to be able to float in a horizontal direction of the second board.

10. A method of manufacturing the motor-integrated electronic control device as claimed in claim 1, comprising:
a first step of forming a first housing assembly by accommodating the first board in the first housing to which the first connector has been attached and fixing the first board to the first housing;
a second step of forming a second housing assembly by accommodating the second board in the second housing to which the second connector has been attached and fixing the second board to the second housing;
a third step of forming an ECU assembly by electrically connecting the first board and the second board and coupling the first housing assembly and the second housing assembly; and
a fourth step of forming the motor-integrated electronic control device by combining the ECU assembly and the motor.

11. The method of manufacturing the motor-integrated electronic control device as claimed in claim 10, further comprising:
a first inspection step of inspecting the ECU assembly between the third step and the fourth step.

12. The method of manufacturing the motor-integrated electronic control device as claimed in claim 11, further comprising:
a second inspection step of inspecting the motor-integrated electronic control device after the fourth step.
